(19) United States
(12) Patent Application Publication
(10) Pub. No.: US 2023/0081319 A1
(43) Pub. Date: Mar. 16, 2023

(54) CONSTRUCTION PROJECT VIDEO-BASED BIDDING, ESCROW AND MILESTONE PAYMENT SYSTEMS AND METHODS

(71) Applicant: Clearbuilt Inc., Lafayette, CO (US)

(72) Inventors: Christopher Roth, Boulder, CO (US); John Van Bockern, Lafayette, CO (US)

(21) Appl. No.: 17/945,821

(22) Filed: Sep. 15, 2022

Related U.S. Application Data
(60) Provisional application No. 63/244,627, filed on Sep. 15, 2021.

(51) Int. Cl. G06Q 50/08; H04L 65/60; G06Q 30/06; G06Q 20/10; G06Q 10/06

(52) U.S. Cl. CPC G06Q 50/08; H04L 65/60; G06Q 30/0611; G06Q 20/10; G06Q 10/063116

(57) ABSTRACT

There is disclosed, in an embodiment, video-based requests for proposals and video-based bids used to create a contract through a set of terms of service, to provide a contract that dictates the release schedule of escrow funds. Embodiments use video and terms of service inside the function of a mobile application program (app) and digitize an escrow account for construction purposes. Embodiments integrate, via the app that is also used for video-based bid solicitation, video-based bidding and video-based milestone reporting and acceptance, to prove project video-based bidding, escrow and milestone payments. Other embodiments are also disclosed.

### CROSS-REFERENCE TO RELATED APPLICATION

This application claims the benefit of U.S. Provisional Patent Application Ser. No. 63/244,627, also entitled Construction Project Video-Based Bidding, Escrow and Milestone Payment Systems and Methods, filed Sep. 15, 2021, which is incorporated herein by reference.

### BACKGROUND

Generally, a construction project begins with a search for an acceptable contractor, or the like. This search is often very time consuming. Oftentimes, it turns out during the course of a project that the property owner's interests are not properly protected by contract, or the like. This often results in a serious and negative financial event should something go awry during the project. Further, it is often the case that no clear path for dispute resolution is provided in such circumstances. Traditionally, an escrow account for a construction project, or the like, involves both parties working with a bank to generate paperwork needed to support an escrow account. Online escrow services, such as those offered by vendors such as ESCROW.COM™, or the like, do not typically deal with construction projects, or the like. Prior systems and methods for gaining access to an escrow account ended with the creation of an escrow account, and previously, digitizing an escrow account for construction purposes has not existed

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided an application program (app) implemented process, wherein recording or uploading a video describing a project, such as a construction project, and showing a site of the project, from a client user is enabled, such as via the app. The app may send the video describing the project and showing the site of the project to one or more service provider users who can carry out the project. The app may enable each of the service provider users to record or upload a video bid for completion of the project. In some embodiments, the app may enable each of the service provider users to request more information, via the app and/or email, more information from the client user about the project, prior to recording or uploading the video bid for completion of the project. The app enables acceptance, by the client user, via the app, of one video bid for completion of the project by a selected one of the service provider users.

The app may then create a contract between the client user and the selected service provider user, wherein the contract includes the video describing the project and showing the site of a project, the video bid for completion of the project from the selected service provider user and a set of terms of service of the app. The app may also establish, as a part of creating the contract between the client user and the selected service provider user, a set of milestones for completion by the selected service provider to complete the project.

The client user may be prompted (by the app) via the app and/or an email, to deposit funds, in the amount of the accepted bid, into an escrow account and the selected service provider may be informed informing (by the app) via the app and/or an email of deposit of the funds in the escrow account and authorization to proceed with the project, in response to the client deposit of the funds in the escrow account. The app may then enable the selected service provider to provide an indication, via the app, of completion of a milestone and acceptance by the client user, via the app, of the completion of the milestone indicated by the selected service provider. Funds may then be released from the escrow account (by the app), in an amount indicated by the contract for completion of the indicated milestone, in response to acceptance of the completion of the indicated milestone by the client user. Acceptance, via the app and/or an email, by the selected service provider of the funds from the escrow account by the selected service provider may then be enabling (by the app).

Other embodiments are also disclosed.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified. Illustrative embodiments of the invention are illustrated in the drawings, in which:

FIG. 1 is a flowchart of an example (application program implemented) construction project video-based bidding, escrow and milestone payment process, according to various embodiments;

FIG. 2 is an example simplified diagrammatic screen shot of a construction project video-based bidding, escrow and milestone payment process application program (app) showing a video submission of a proposal by a contractor for acceptance by a property owner, according to some embodiments;

FIG. 3 is an example simplified diagrammatic screen shot of the construction project video-based bidding, escrow and milestone payment process app prompting the property owner to deposit funds, in the amount of the accepted bid, into an escrow account, according to some embodiments;

FIG. 4 is an example simplified diagrammatic screen shot of the construction project video-based bidding, escrow and milestone payment process app showing an example interface for a contractor to submit a video to prove a milestone “hit,” according to some embodiments;

FIG. 5 is an example simplified diagrammatic screen shot of the construction project video-based bidding, escrow and milestone payment process app showing an example interface for the owner to accept a milestone and release funds from the escrow to the contractor, according to some embodiments;

FIG. 6 is an example simplified diagrammatic screen shot of the construction project video-based bidding, escrow and milestone payment process app showing an example timeline, according to some embodiments;

FIG. 7 is a simplified diagrammatic flow illustration of screen shots of the construction project video-based bidding, escrow and milestone payment process app showing an example partially completed timeline and an example (retrieved) review process, according to some embodiments;

FIG. 8 is a block diagram of an example construction project video-based bidding, escrow and milestone payment system, according to some embodiments; and

FIG. 9 is a block diagram depicting certain components of a computer system or device configured to implement various techniques disclosed herein, according to some embodiments.

### DETAILED DESCRIPTION

Embodiments are described below in sufficient detail to enable those skilled in the art to practice the system and method. However, embodiments may be implemented in many different forms and should not be construed as being limited to the embodiments set forth herein. The following description is, therefore, not to be taken in a limiting sense.

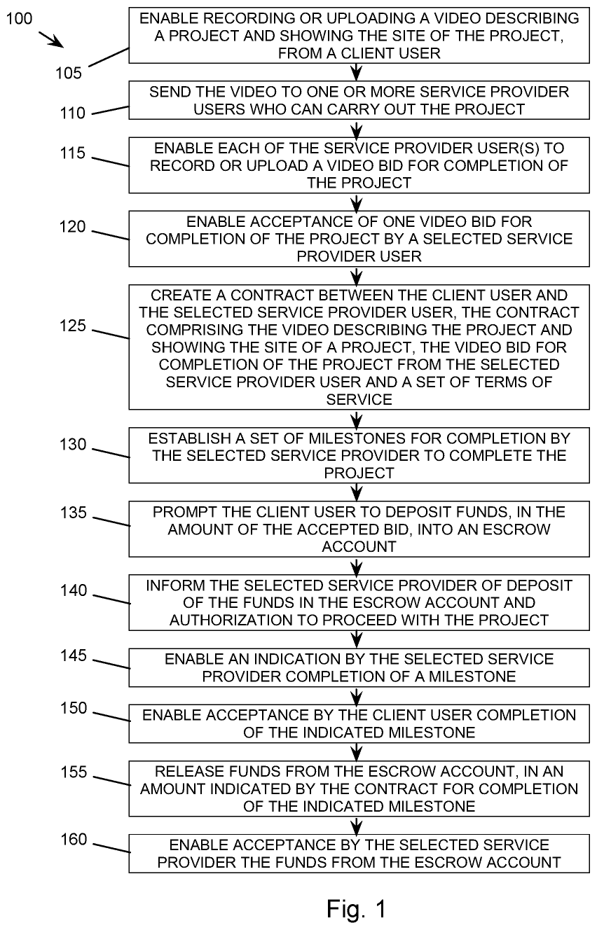

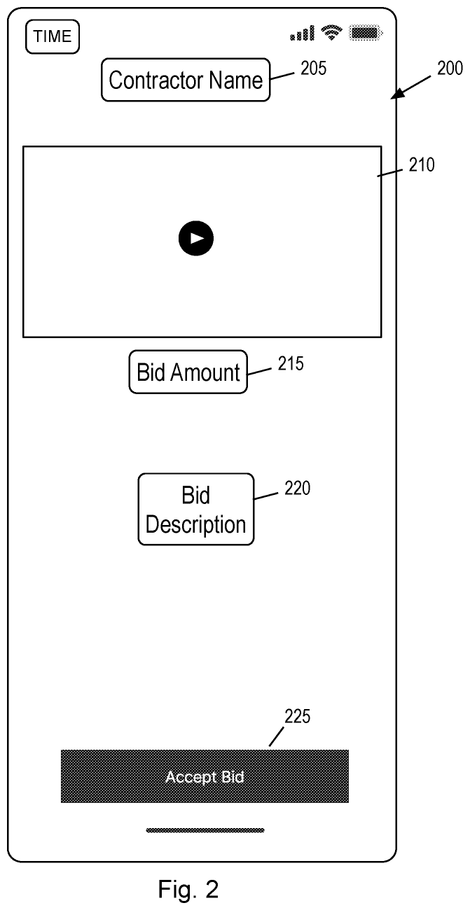

FIG. 1 is a flowchart of example application program (app) implemented construction project video-based bidding, escrow and milestone payment process 100, according to various embodiments of the present systems and methods. FIGS. 2 through 5 are various example simplified diagrammatic screen shots of the app implementing various aspects of the present systems and methods, as parenthetically indicated below and described further below.

Embodiments of the present systems and methods ease the inefficiencies of the search for the right contractor. At 105, embodiments of a construction project video-based bidding, escrow and milestone payment process app practicing the present systems and methods asks a client user of the app, such as the property owner to describe their construction needs through a video, by enabling recording and/or uploading one or more videos describing the project and showing the site of the project. Advantageously, the present systems and methods enable the property owner to only submit this video and request for bids only once.

At 110, the construction project video-based bidding, escrow and milestone payment process app then sends the video describing the project and showing the site of the project to service provider app users, such as contractors, and the like, who can accomplish what the property owner is seeking. The recipient contractors may thereby easily see the scope of the project, request more information from the property owner, or at 115, submit a (video) recorded description of their bid. To such ends, the construction project video-based bidding, escrow and milestone payment process app may, at 115, enable the contractor, or the like, to record or upload a video bid for completion of the project.

Along with bringing efficiency to the bid process as described above, embodiments of the present systems and methods protects both the property owner's and the contractor's interests in situations that many times are not protected by contract, or the like. To this end, embodiments of the present systems and methods create a contract through the use of a set of terms of service, which have previously been accepted by both the property owner and contractor, combined with the above-described process of a video request for proposal (RFP) and video submission of the proposal by a contractor, at 115, along with the following. At 120, the construction project video-based bidding, escrow and milestone payment process app enables the property owner to accept one video bid for completion of the project by that contractor (See FIG. 2 described below). This results in the above described creation of the contract between the property owner and the selected contactor, at 125, wherein the contract comprises the video, from 105, describing the project and showing the site of a project, the video bid for completion of the project from the selected contractor, from 115, and the mutually accepted set of terms of service of the app. At 130, as a part of creating the contract between the property owner and the contractor, a set of milestones for completion by the contractor to complete the project are created and descriptions of payment release milestones that are to be met, which are collected within the construction project video-based bidding, escrow and milestone payment process app and accepted by both parties before (the entirety of) the funds for the project are deposited in the escrow account, all carried out via the present app.

Escrow payment may be provided in accordance with various embodiments of the present systems and methods in various manners. That is, the escrow payment feature for the construction project video-based bidding, escrow and milestone payment process app may be able to be accomplished in a number of different ways. For example, a number of existing companies offer a function of paying in and out of accounts. So, implementation of the escrow account function in accordance with embodiments of the present systems and methods can be carried out in various ways.

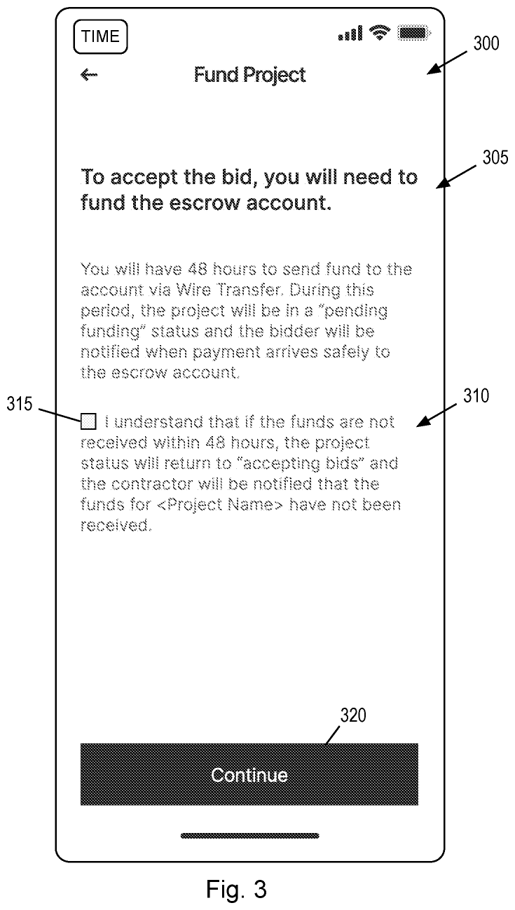

Following this proposal process, the following payment flow may proceed in accordance with various embodiments, including a minimal viable product (MVP). For example, in one iteration email may be utilized to process the payment. In other iterations a more programmatic version may utilize payment operation solutions that automate the full cycle of money movement, such as a payment operations platform and an application program interface (API) integrated into the present construction project video-based bidding, escrow and milestone payment process app to enable money movement and tracking. Such payment platforms may include business-to-business secure payments platforms such as MODERN TREASURY™, DWOLLA™, ROUTABLE™, or the like. Thus, in various embodiments of the present systems and methods, no account information is collected by the operator of the present systems and methods. Following (i.e., as a result of) bid acceptance, an email, and/or construction project video-based bidding, escrow and milestone payment process app message (e.g., a (push) notification), may be sent at 135 to the owner with instructions (how) to wire funds into the escrow account. (See FIG. 3, described below.) This escrow account may be administered by an operator of the present systems and methods, or by a “partner” (entity) with an escrow license, or the like. Alternatively, as noted the funds may be maintained in a payments platform, such as MODERN TREASURY™, DWOLLA™, ROUTABLE™, or the like. Once the money arrives in the escrow account. For example, at 135, the property owner may be prompted by the construction project video-based bidding, escrow and milestone payment process app, via the app and/or via an email, to deposit funds, in the amount of the accepted bid, into an escrow account. In accordance with various embodiments, the terms of service under the present systems and methods provides that both parties recognize that by submitting a request for proposal (at 105), accepting a bid on the app (at 115), and depositing funds into the escrow account (at 135), to be released when work is completed or milestones met, a clear intention has been expressed and therefore a contract created between the parties involved.

In accordance with the foregoing, an email and/or a (push) notification through the construction project video-based bidding, escrow and milestone payment process app, may be issued informing the service provider of the accepted bid. This message may not only indicate that the project creator has accepted the bid, but also that the project is pending funding that the project corrector has, by way of example, 48 hours, to fund the project and that the present systems and methods will inform the service provider when an operator of the present systems and methods has received the escrow funds and the service provider can begin work. Thereafter, an email and/or (push) notification from the construction project video-based bidding, escrow and milestone payment process app, may be issued, at 140, informing the service provider of project funding, indicating that the operator has received the escrow funds from the project creator for the project and indicating the service provider is cleared to begin work.

However, if the project is not (timely) funded by the project creator, an email informing the service provider of the project not being funded may be sent. This email may indicate that the operator did not receive the funding for the escrow account, such as, by way of example, within 48 hours, and that the operator has set the project's status back to “accepting bids, or the like. This notice may also clarify that this is happening since the project poster accepted the service provider's bid but failed to wire the money in time.

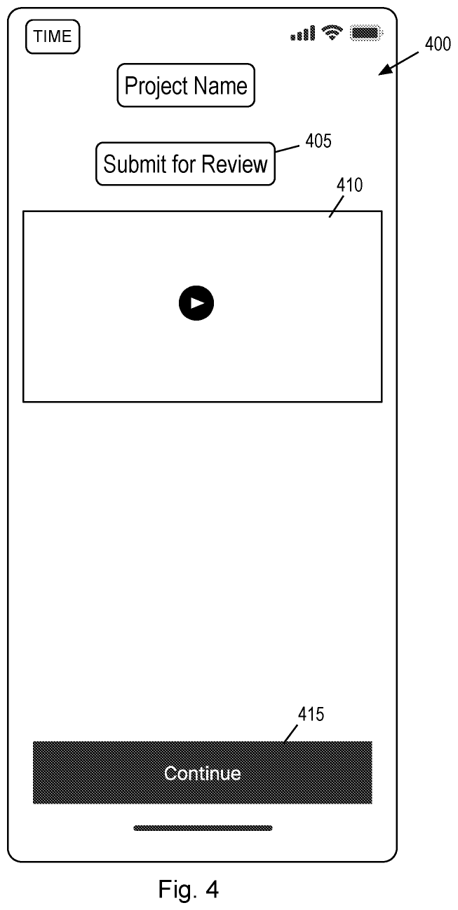

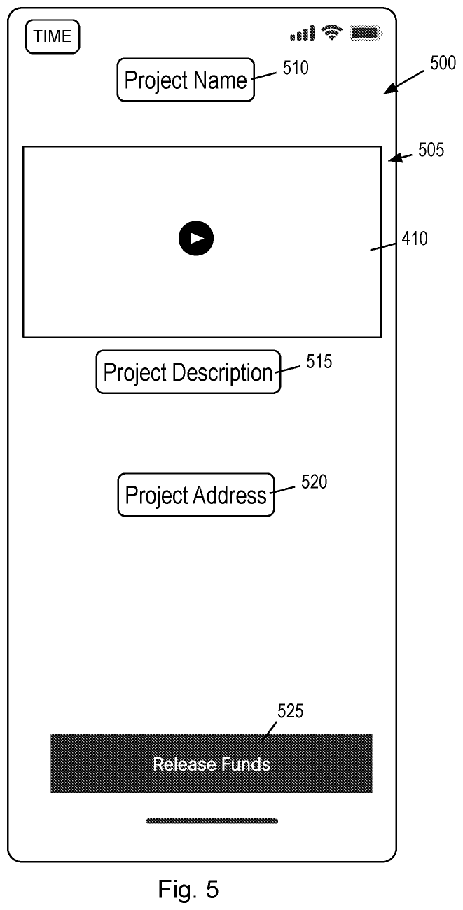

Once work has begun, a video may be submitted by the contractor, in accordance with embodiments of the present systems and methods, proving a milestone “hit.” For example, at 145 the construction project video-based bidding, escrow and milestone payment process app may enable the contactor to indicate completion of a milestone, such as by providing the contractor an interface, in the app, to record and/or upload a video proving completion of the milestone. (See, FIG. 4, discussed below.) Thereafter, the owner may accept the milestone, such as via a construction project video-based bidding, escrow and milestone payment process app interface provided at 150 to enable the property owner to accept completion of the indicated milestone. (See, FIG. 5, described below). Such acceptance may, in accordance with the present systems and methods, result in release of funds from the escrow, through the payments platform, at 155, which sends an email link, or a (push) notification, via the construction project video-based bidding, escrow and milestone payment process app to the contractor, at 160, enabling the contractor to accept payment. For example, after acceptance of the milestone, by the property owner (at 150), the operator may, in accordance with embodiments of the present systems and methods, receive a notification that the project was completed (or a milestone met) and may initiate payment from the escrow account to the service provider (at 155) using a business-to-business secure payments platform. Whereupon, an email or construction project video-based bidding, escrow and milestone payment process app (push) notification informing the service provider of payment may be issued, at 160, indicating that the project creator has approved the project and released funds. This email or (push) notification may include a link or button to “accept payment,” or the like. In accordance with embodiments of the present systems and methods, when the service provider clicks “accept payment,” they are taken to an operator-branded page of the business-to-business secure payments platform, or the like, where they may enter bank account information, and then business-to-business secure payments platform may then handle transfer of the funds, via ACH, or the like.

Thereafter, an email or (push) notification informing the project owner of payment may be sent. This email or (push) notification may identify the project and inform the owner that funds for the project were released. For example, the email or (push) notification may inform the owner that they have released the funds for the project and that the service provider will be paid, such as within one to five business days. This email and/or (push) notification will, in accordance with embodiments of the present systems and methods, act as a confirmation to the project creator, such that they have written confirmation that they released the funds.

Thusly, the present systems and methods include payment features offered through the app, namely an escrow account from which funds are released on milestones set by descriptions shared through the app. The milestones are approved and accessible, via the app, between the person requesting the service (e.g., property owner) and the service provider (e.g., contractor).

In accordance with various embodiments an operator of the present systems and methods may collect a fee (e.g., a one percent fee), such as may be based on and drawn from funds deposited and released from the escrow account.

In situations where release of an escrow payment presents a problem for the property owner (e.g., homeowner) such as where the owner does not want to pay out, the operator of the present systems and methods may not be part of the dispute resolution. Therefore, the construction project video-based bidding, escrow and milestone payment process app may, in accordance with embodiments of the present systems and methods, clearly communicate to both parties that the terms of service dictates that the operator of the present systems and methods will not be handling dispute resolution. However, an option presented via the construction project video-based bidding, escrow and milestone payment process app for accepting the video proof that a milestone has been met or the project is finished may be presented adjacent to clickable text, or the like, prompting a user to contact an attorney, which may take the user to a list of law firms (such as law firms specializing in construction law, or the like) for dispute resolution.

Embodiments of the present systems and methods combines an improved way to request a bid, through video, thereby improving the process for request for proposal. In the present systems and methods, the bid submission process is improved, for example, more information can be gleaned from a video than form a phone call. Finally, the present terms of service are combined with, the request for bid, the bid submittal and acceptance through the construction project video-based bidding, escrow and milestone payment process app to create a contract that defines the release schedule of the escrow account for payments to be made on the project.

FIG. 2 is an example simplified diagrammatic screen shot from the construction project video-based bidding, escrow and milestone payment process app, showing interface 200 for playing a video submission of a proposal by contractor 205 for acceptance by a property owner, according to some embodiments. The property owner may view the contractor's video submission 210 and review the displayed bid amount 215 and bid description 220. Button 225 may be used to accept the bid from contractor 205.

FIG. 3 is an example simplified diagrammatic screen shot 300 of the construction project video-based bidding, escrow and milestone payment process app prompting the property owner to deposit funds, in the amount of the accepted bid, into an escrow account, according to some embodiments, which may be displayed as a result of acceptance of the proposal via button 225. Screen 300 presents text 305 that explains that to complete acceptance of the bid the property owner will need to fund the project by funding the escrow account. At 310, screen 300 warns the property owner that if the project is not timely funded, such as within the indicated 48 hours, the contractor will be notified that the funds have not been received. Check box 315 is provided for the property own to indicate that the understand (and accept) this requirement to fund the escrow account in the indicated time frame (e.g., 48 hours) in order to complete acceptance of the bid. Such indication of understanding may be submitted by clicking continue bar 320.

FIG. 4 is an example simplified diagrammatic screen shot of the construction project video-based bidding, escrow and milestone payment process app showing example interface 400 for a contractor to record, download and submit, via button 405 video 410 to prove a milestone “hit,” according to some embodiments. Following submission of video 410, or to leave screen 400 without submitting a video continue bar 415 may be used.

FIG. 5 is an example simplified diagrammatic screen shot of the construction project video-based bidding, escrow and milestone payment process app showing example interface 500 for the owner to accept a milestone and release funds from the escrow to the contractor, according to some embodiments. Video area 505 displays contractor video 410 submitted by the contactor to prove the milestone has been met for release of funds, for review by the property owner. Project name, description and address fields 510, 515 and 520 confirm the identification of the subject project. Bar 525 may be used by the owner to accept the milestone and release funds for completion of the milestone from the escrow, to the contractor.

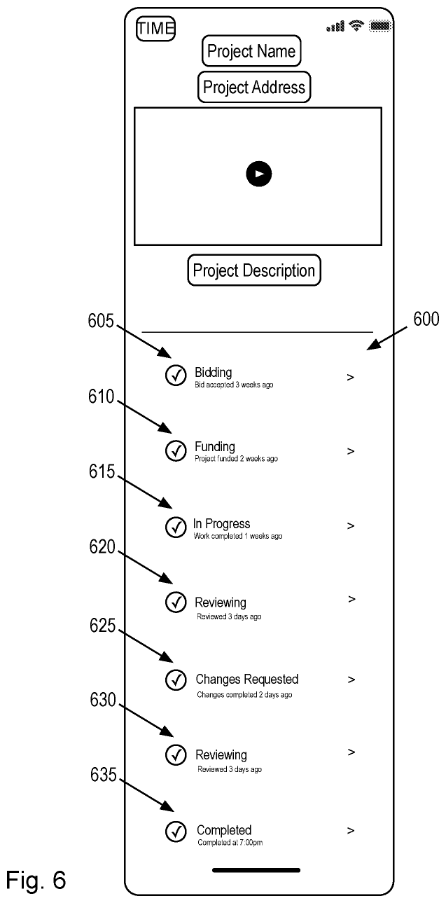

FIG. 6 is an example simplified diagrammatic screen shot of the construction project video-based bidding, escrow and milestone payment process app showing example timeline 600, according to some embodiments. Timeline 600 documents the back and forth between parties and may be the default screen initially displayed when a particular project is selected. This timeline is organized according to the stages of the project, such that each timeline entry, 605 through 635, may represent a step in the project, and may include a notation of when (how long ago) each step was completed. This timeline functionality may compile, and present for display, the messages shared between the two parties. This timeline may pull communications for the parties' email, text messages, and the like, as well as pulling information for project management and communication systems, such as BUILDERTREND™, COMPANYCAM™, SITEPLAN™, PLANGRID™, or the like, which may be integrated into the construction project video-based bidding, escrow and milestone payment process app, as well.

In the example shown in FIG. 6 selection of bidding timeline entry 605 would, by way of example display the request for bid (105), the bid (115), the acceptance of bid (120), etc. Selection of funding entry 610 may show the prompting for (135), and funding of, the escrow account, including informing the contactor of the funding (140). As noted, there is a proof of completion of contract, through the app by the contractor, such as by enabling the contactor to prove completion of milestones thorough videos, or the like (150), which may result in releases of payments, and becomes part of the timeline feature as well, such as a part of “in-progress” entry 615. As discussed below, final project review 620 may result in changes requests 625, which may prompt a further final project review 630. Once the job is completed, this may be indicated in entry 635.

Timeline 600 is illustrated in FIG. 6 in top-to-bottom (“top-down”) chronological order. However, the timeframe may be presented in a “bottom-up” (reverse) chronological order, showing the currently pending action at the top, which may alleviate the need to scroll down to find the active entry, etc. Additionally, or alternatively, the (basic) steps may all be shown as completed or uncompleted, or in other implementations the entries may only be shown, as they are initiated and completed. For example, once bidding 605 is complete, funding entry 610 may be shown (as pending, such as without the illustrated checkmark). These options, top-down, bottom-up, show completed and working, show all, etc. may be configured by the user (property owner or contractor) in a settings menu, or the like, of the construction project video-based bidding, escrow and milestone payment process app.

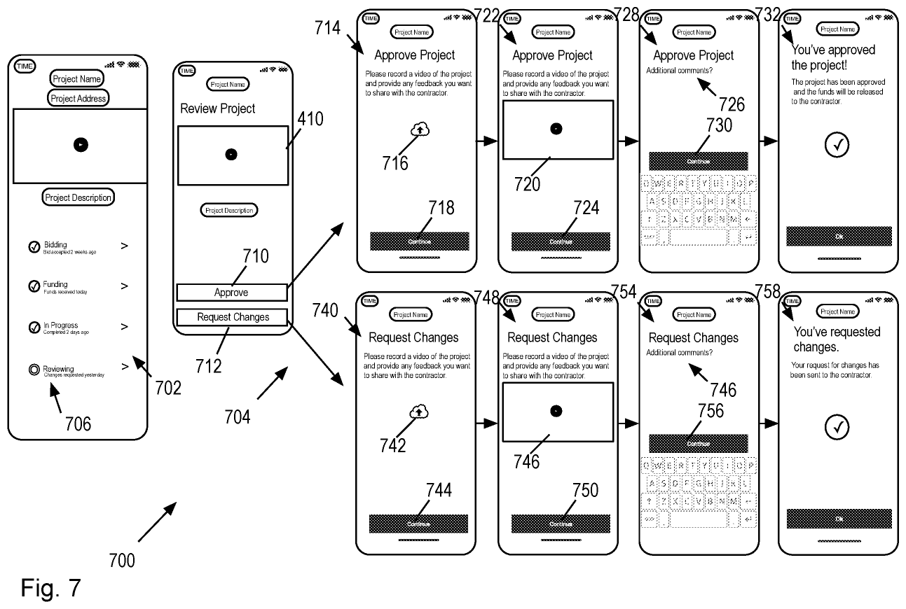

As noted, final project review 620 may result in changes requests 625. FIG. 7 is a simplified diagrammatic flow illustration 700 of screen shots of the construction project video-based bidding, escrow and milestone payment process app showing example partially completed timeline 702 and (retrieved) review process 704, according to some embodiments.

As noted above, selection of a timeline entry, such as review 706 may show the steps completed during that timeline entry, such as from the steps described below which may fall under approval of the project (or a milestone) or a request for change(s).

Review process 704, may enable the owner to approve the project (overall), or a milestone, or to request changes. Therein, review screen 708 may be presented as a part of enabling acceptance completion of the milestone indicated, or the project overall, as illustrated, by the property owner. This screen may be presented at 150 as described above, as a part of release of funds at 155, such as, in some embodiments, in lieu of screen 500 of FIG. 5. In screen 708, the owner may be presented video 410 recorded or downloaded by the contactor at 145, in screen 400 of FIG. 4, above. The property owner may approve the milestone, or the project overall, as illustrated, by selections of approve button 710 or may request changes by selection of request changes button 712.

Selection of approve button 710 results in presentation of screen 714, wherein the property owner may upload (716) a video to send to the contractor, and/or the property owner by select continue 718 and record video 720 to send to the contactor in screen 722. Additionally, or alternatively, as a result of section of continue 724, in screen 722, the property owner may type-in comments 726 to the contractor in screen 728 and/or select continue 730. Whereupon, the property owner is presented with confirmation screen 732 confirming that they have approved the milestone, or project overall, as illustrated, and that the funds have been released to the contactor.

However, selection of request changes button 712 in screen 708 results in presentation of request changes screen 740, wherein the property owner may upload 742 a video to send to the contractor, and/or the property owner by select continue 744 and record video 746 to send to the contactor in screen 748. Additionally, or alternatively, as a result of selection of continue 750, in screen 748, the property owner may type-in change request comments 752 to the contractor in screen 754 and/or select continue 756, whereupon the property owner is presented with change request confirmation screen 758 confirming that their request for changes has been sent to the contractor.

Also, the construction project video-based bidding, escrow and milestone payment process app may include software and hardware integration with a camera set up on site, which monitors real-time progress of the project. For example, a video feed may be provided via a wireless network, such as, or including, the internet, which may be accessed in the construction project video-based bidding, escrow and milestone payment process app, by the property owner to monitor real-time progress of the project, or which in some embodiments may be monitored by the contractor to monitor real time work being performed by employees, subcontractors, or the like. In accordance with some embodiments this video may feed into the timeline functionality, and may be accessed, by way of example, through in-progress entry 615.

Video-based requests for proposals and video based bids, that create a contract through a set of terms of service, to provide a contract that dictates the release schedule of escrow funds are not well-understood, routine, conventional activity in the field. Embodiments of the present systems and methods use video and terms of service inside the function of a mobile application, to accomplish what has previously been a lengthy process, in contrast to what is well-understood, routine, conventional activity in the field. Traditionally, an escrow account for a construction project involves both parties working with a bank to generate paperwork needed to support an escrow account. Regardless, such bank-based escrow services, or other escrow services, such as those offered by vendors such as ESCROW.COM™ or the like are not video-based. Further, escrow services, such as those offered by vendors such as ESCROW.COM™ or the like do not typically deal with construction projects, or the like. For example, prior systems and methods for gaining access to an escrow account ended with the creation of an escrow account, but previously digitizing an escrow account for construction purposes has not existed, particularly so, through implementation via an construction project video-based bidding, escrow and milestone payment process app that is also used for video-based bid solicitation, video-based bidding and video-based milestone reporting and acceptance, integrated such as in accordance with embodiments of the present systems and methods.

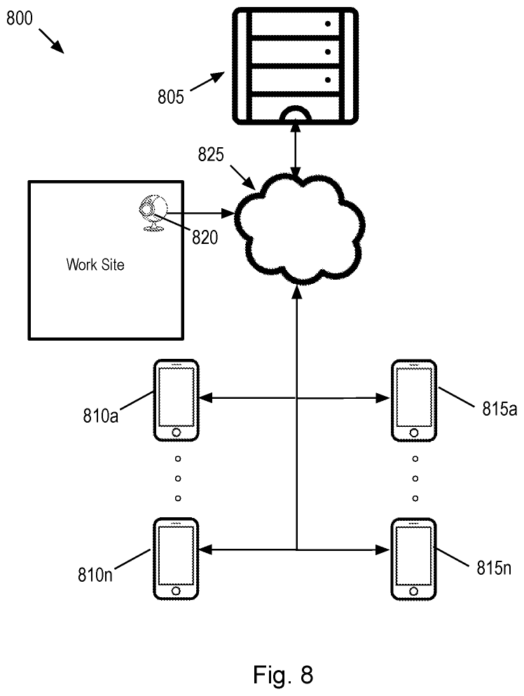

FIG. 8 is a block diagram of example construction project video-based bidding, escrow and milestone payment system 800, according to some embodiments. System 800 includes server 805, client (property owner) user devices 810 a-n, service provider devices 815a-n and, in some embodiments site camera(s) 820, all linked via network 825, which may be one or more wireless (cellular) (data) communications networks.

Consistent with the foregoing descriptions, each client user device 810a-n comprises a processor and a memory configured to store construction project video-based bidding, escrow and milestone payment process app instructions that are configured for execution by the client user device process to enable recording or uploading, via the app on the client user device, a video describing a project and showing a site of the project, from the client user and sending of the video to one or more service provider users (such as may be identified by server 805) who can carry out the project.

Server 805, or the like, may host, develop and use databases, in which tables may include, by way of example, self-referential tables of service providers (contractors), so as to provide a self-referential database. Therein, all service provider types providing a particular service can be stored in a single table and the table rows can contain information defining the table columns, resulting in (eventually, deeply) nested hierarchies of service providers. Such self-referencing databases and tables provide significant advantages and benefits over conventional databases, such as increased flexibility, faster search times, and smaller memory requirements. Further, such self-referential databases and tables may be developed using, and/or may be used by, machine learning to provide a depth to selection of one or more service providers who can carry out the project that results in significantly improved outcomes. That is machine learning may not only enable implementation of self-referencing databases and tables to create deeply nested hierarchies of service provider who can carry out the project, but also provide a mechanism to explore such nested hierarchies of service provider outcomes for each specific project. Additionally, or alternatively, server 805, or the like, may use a database tool for data fusion and cross-correlation for identification of one or more service provider users who can carry out the project. “Data fusion” is a process of integrating multiple data sources to produce more consistent, accurate, and useful information than that provided by any individual data source. Further, self-referential databases and tables may be developed using, and/or may be used by, data fusion, machine learning, and/or the like to provide a greater depth to the identification of identification of one or more service provider users who can carry out the project.

Each of service provider user devices 815a-n also comprises a processor and a memory configured to store the construction project video-based bidding, escrow and milestone payment process app program instructions configured for execution by the service provider user device to enable, via the app on each of the one or more service provider user devices, each of the one or more service provider users to record or upload a video bid for completion of the project.

The client user devices may be caused to enable the client user to accept, via the app on the client user device, of one video bid for completion of the project by a selected one of the one or more service provider users.

This may, in accordance with embodiments of the present systems and methods, create a contract between the client user and the selected service provider user, the contract comprising the video describing the project and showing the site of a project, the video bid for completion of the project from the selected service provider user and a set of terms of service of the app. As a part of creating the contract between the client user and the selected service provider user, a set of milestones for completion by the selected service provider to complete the project may also be established.

The client user devices may then be caused to prompt the client user, via the app on the client user device and/or via an email, to deposit funds, in the amount of the accepted bid, into an escrow account.

The selected service provider's device may then be caused to inform, via the app on the selected service provider's device and/or in an email, in response to deposit of the funds in the escrow account, the selected service provider of deposit of the funds in the escrow account and authorization to proceed with the project. Thereafter, the selected service provider's device may then be caused to enable an indication, via the app on the selected service provider device, by the selected service provider, completion of a milestone by the selected service provider.

The client user devices may then be caused to enable acceptance by the client user, via the app on the client user device, completion of the milestone indicated by the selected service provider. Whereupon, funds from the escrow account, are release (such as by server 805) in an amount indicated by the contract for completion of the indicated milestone, in response to acceptance of the completion of the indicated milestone by the client user.

The selected service provider's device may then be caused to enable acceptance by the selected service provider, via the app on the selected service provider device and/or via email, the funds from the escrow account.

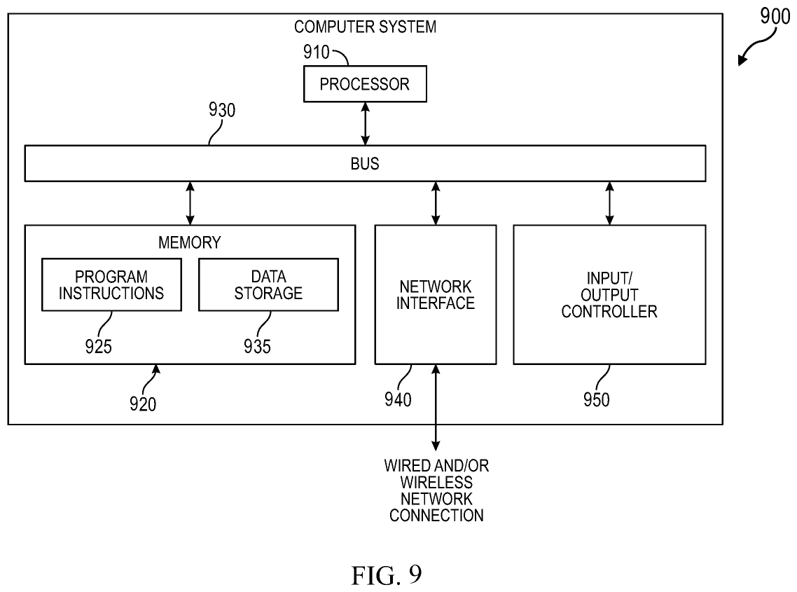

Server 805, portions of client (property owner) user devices 810 a-n, portions of service provider devices 815a-n and, in some embodiments at least portions of site camera(s) 820 may be implemented, at least in part, by a computer system. One such computer system is illustrated in FIG. 9. In various embodiments, computer system 900 may be a wireless communications device such as a smartphone, tablet computing device, or the like. For example, in some cases, computer 900 may implement one or more steps of example processes 100 described above with respect to FIGS. 1 through 8. In various embodiments computer system 900 may be configured to communicate in any suitable way, such as, for example, via a public network, which may be the Internet and/or one or more wireless (cellular) (data) communications networks, or the like, as discussed above, via a local area network using wired or wireless functionality, etc.

As illustrated, computer system 900 includes one or more processors 910 (and/or one or more processors having one or more processor cores, a processor with an integrated graphics processor, and/or the like) coupled to a system memory 920 via bus 930. Computer system 900 further includes a network interface 940 coupled to bus 930, and one or more I/O controllers 950, which in turn may provide optional connectivity for peripheral devices, such as for a cursor control device (mouse, trackball, or the like), keyboard, (touch) display(s), etc. Such I/O devices may be capable of communicating with I/O controller 950, for example, via a wired connection (e.g., serial port, Universal Serial Bus port) or wireless connection (e.g., Wi-Fi, Bluetooth, Near Field Communications Link, etc.). Other devices may include, for example, microphones, speakers, antennas/wireless transducers, etc.

In various embodiments, computer system 900 may be a single-processor system including one processor 910, or a multi-processor system including two or more processors 910, and/or or cores in one or more processors (e.g., two, four, eight, or another suitable number). Processor(s) 910 may be any processor capable of executing program instructions. For example, in various embodiments, processor(s) 910 may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 910 may commonly, but not necessarily, implement the same ISA. Also, in some embodiments, at least one processor 910 may be, or may include, a graphics processing unit (GPU) or another dedicated graphics-rendering device.

System memory 920 may be configured to store program instructions and/or data accessible by processor 910. In various embodiments, system memory 920 may be implemented using any suitable memory technology, such as static random-access memory (SRAM), synchronous dynamic RAM (SDRAM), nonvolatile/Flash-type memory, or any other type of memory. As illustrated, program instructions and data implementing certain operations and modules such as those described herein may be stored within system memory 920 as program instructions 925 and data storage 935, respectively. In other embodiments, program instructions and/or data may be received, sent, or stored upon different types of computer-accessible media or on similar media separate from system memory 920 or computer system 900.

A computer-accessible medium may include any tangible and/or non-transitory storage media or memory media such as electronic, magnetic, or optical media—e.g., disk or CD/DVD-ROM coupled to computer system 900 via bus 930. The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer-readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 930 may be configured to coordinate I/O traffic between processor 910, system memory 920, and any peripheral devices in the computer system, including network interface 940 or other peripheral interfaces. In some embodiments, bus 930 may perform any necessary protocol, timing, or other data transformations to convert data signals from one component (e.g., system memory 920) into a format suitable for use by another component (e.g., processor 910). In some embodiments, bus 930 may include support for devices attached through various types of peripheral buses, such as a variant of the Peripheral Component Interconnect (PCI) bus standard or the Universal Serial Bus (USB) standard, for example. In some embodiments, the function of bus 930 may be split into two or more separate components, such as a northbridge chipset and a southbridge chipset, for example. In addition, in some embodiments some or all the functionality of bus 930, such as an interface to system memory 920, may be incorporated directly into processor(s) 910.

Network interface 940 may be configured to allow data to be exchanged between computer system 900 and other devices attached to a network, such as other computer systems, or between nodes of computer system 900. In various embodiments, network interface 940 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

I/O controllers 950 may, in some embodiments, enable communications with one or more display terminals, keyboards, keypads, touchpads, touch screens, scanning devices, voice or optical recognition devices, mobile devices, or any other devices suitable for entering or retrieving data by one or more computer system 900. Multiple I/O controllers 950 may be present in computer system 900 or may be distributed on various nodes of computer system 900. In some embodiments, I/O devices may be separate from computer system 900 and may interact with one or more nodes of computer system 900 through a wired or wireless connection, such as over network interface 940.

As shown in FIG. 9, system memory 920 may include program instructions 925, configured to implement certain embodiments described herein, and data storage 935, comprising various data may be accessible by program instructions 925. In an embodiment, program instructions 925 may include software elements, which may be configured to affect the operations discussed in FIGS. 1 through 9. Program instructions 925 may be implemented in various embodiments using any desired programming language, scripting language, or combination of programming languages and/or scripting languages (e.g., C, C++, C#, JAVA®, JAVASCRIPT®, PERL® etc.). Data storage 935 may include data that may be used in these embodiments (e.g., recorded communications, profiles for different modes of operations, etc.). In other embodiments, other or different software elements and data may be included.

A person of ordinary skill in the art will appreciate that computer system 900 is merely illustrative and is not intended to limit the scope of the disclosure described herein. The computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be provided and/or other additional operations may be available. Accordingly, systems and methods described herein may be implemented or executed with other computer system configurations.

The various operations described herein may be implemented in software executed by processing circuitry, hardware, or a combination thereof. The order in which each operation of a given method is performed may be changed, and various operations may be added, reordered, combined, omitted, modified, etc. It is intended that embodiment(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

To implement various operations described herein, computer program code (i.e., instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices.

In various embodiments, aspects of systems and methods described herein may be implemented, at least in part, using machine learning (ML). As used herein, the terms “machine learning” or “ML” refer to one or more algorithms that implement: a neural network (e.g., artificial neural network, deep neural network, convolutional neural network, recurrent neural network, autoencoders, reinforcement learning, etc.), fuzzy logic, artificial intelligence (AI), deep learning, deep structured learning hierarchical learning, support vector machine (SVM) (e.g., linear SVM, nonlinear SVM, SVM regression, etc.), decision tree learning (e.g., classification and regression tree or “CART”), Very Fast Decision Tree (VFDT), ensemble methods (e.g., ensemble learning, Random Forests, Bagging and Pasting, Patches and Subspaces, Boosting, Stacking, etc.), dimensionality reduction (e.g., Projection, Manifold Learning, Principal Components Analysis, etc.), or the like.

Non-limiting examples of publicly available machine learning algorithms, software, and libraries that may be utilized within embodiments of systems and methods described herein include, but are not limited to: PYTHON, OPENCV, INCEPTION, THEANO, TORCH, PYTORCH, PYLEARN2, NUMPY, BLOCKS, TENSORFLOW, MXNET, CAFFE, LASAGNE, KERAS, CHAINER, MATLAB Deep Learning, CNTK, MatConvNet (a MATLAB toolbox implementing convolutional neural networks for computer vision applications), DeepLearnToolbox (a Matlab toolbox for Deep Learning from Rasmus Berg Palm), BigDL, Cuda-Convnet (a fast C++/CUDA implementation of convolutional or feed-forward neural networks), Deep Belief Networks, RNNLM, RNNLIB-RNNLIB, matrbm, deeplearning4j, Eblearn.lsh, deepmat, MShadow, Matplotlib, SciPy, CXXNET, Nengo-Nengo, Eblearn, cudamat, Gnumpy, 3-way factored RBM and mcRBM, mPoT, ConvNet, ELEKTRONN, OpenNN, NEURALDESIGNER, Theano Generalized Hebbian Learning, Apache SINGA, Lightnet, and SimpleDNN.”

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. A construction project video-based bidding, escrow and milestone payment system comprising:
a server;
one or more service provider user devices, each service provider user device comprising a processor and a memory configured to store application program instructions configured for execution by the service provider user device; and
a client user device comprising a processor and a memory configured to store the application program instructions configured for execution by the client user device;
whereupon execution of the application program instructions by the respective service provider user device processor or client user device processor cause the respective service provider user device or client user device to:
enable recording or uploading, via the application program on the client user device, a video describing a project and showing a site of the project, from a client user;
send, via the application program on the client user device, the video describing the project and showing the site of the project to one or more service provider users who can carry out the project;
enable, via the application program on each of the one or more service provider user devices, each of the one or more service provider users to record or upload a video bid for completion of the project;
enable acceptance by the client user, via the application program on the client user device, of one video bid for completion of the project by a selected one of the one or more service provider users;
create a contract between the client user and the selected service provider user, the contract comprising the video describing the project and showing the site of a project, the video bid for completion of the project from the selected service provider user and a set of terms of service of the application program;
establish, as a part of creating the contract between the client user and the selected service provider user, a set of milestones for completion by the selected service provider to complete the project;
prompt the client user, via the application program on the client user device and/or via an email, to deposit funds, in the amount of the accepted bid, into an escrow account;
inform, via the application program on the selected service provider's device and/or an email, in response to deposit of the funds in the escrow account, the selected service provider of deposit of the funds in the escrow account and authorization to proceed with the project;
enable an indication, via the application program on the selected service provider device, by the selected service provider completion of a milestone by the selected service provider;
enable acceptance by the client user, via the application program on the client user device, completion of the milestone indicated by the selected service provider;
releasing funds from the escrow account, in an amount indicated by the contract for completion of the indicated milestone, in response to acceptance of the completion of the indicated milestone by the client user; and
enable acceptance by the selected service provider, via the application program on the selected service provider device and/or an email, the funds from the escrow account.

2. A method comprising:
enabling recording or uploading, by an application program, a video describing a project and showing a site of the project, from a client user;
sending, by the application program, the video describing the project and showing the site of the project to one or more service provider users who can carry out the project;
enabling, by the application program, each of the one or more service provider users to record or upload a video bid for completion of the project;
enabling, by the application program, acceptance by the client user, via the application program, one video bid for completion of the project by a selected one of the one or more service provider users;
creating, by the application program, a contract between the client user and the selected service provider user, the contract comprising the video describing the project and showing the site of a project, the video bid for completion of the project from the selected service provider user and a set of terms of service of the application program;
establishing, by the application program, as a part of creating the contract between the client user and the selected service provider user, a set of milestones for completion by the selected service provider to complete the project;
prompting the client user, by the application program via the application program, and/or via an email, to deposit funds, in the amount of the accepted bid, into an escrow account;
informing (by the application program) via the application program and/or an email, in response to deposit of the funds in the escrow account, the selected service provider of deposit of the funds in the escrow account and authorization to proceed with the project;
enabling, by the application program, an indication by the selected service provider, via the application program, completion of a milestone by the selected service provider;
enabling, by the application program, acceptance by the client user, via the application program, completion of the milestone indicated by the selected service provider;
releasing (by the application program) funds from the escrow account, in an amount indicated by the contract for completion of the indicated milestone, in response to acceptance of the completion of the indicated milestone by the client user; and
enabling (by the application program) acceptance by the selected service provider, via the application program and/or an email, the funds from the escrow account.

3. The method of claim 2, wherein the project is a construction project.

4. The method of claim 2, further comprising enabling, by the application program, each of the one or more service provider users to request more information, via the application program and/or email, from the client user about the project prior to recording or uploading the video bid for completion of the project.

5. The method of claim 2, further comprising presenting, via the application program a timeline of stages of the project.

6. The method of claim 5, wherein the stages of the project comprise bidding, funding, in-progress, reviewing, and completed.

7. The method of claim 6, wherein the stages of the project further comprise changes requested.

8. The method of claim 2, further comprising, informing, by the application program, via the application program and/or an email, in response to the client user accepting the bid for completion of the project from the selected service provider user, the selected service provider user of the acceptance of the bid, that the project is pending funding, the time the client user has to fund the project, and that the selected service provider user will be informed of deposit of the funds in the escrow account and authorization to proceed with the project.

9. The method of claim 2, wherein enabling acceptance by the client user completion of the milestone indicated by the selected service provider further comprises:
presenting, by the application program, the indication by the selected service provider of completion of the milestone to the client user; and
enabling, by the application program, a selection by the client user between the acceptance of the milestone and a request for changes.

10. The method of claim 9, further comprising, in response to selection of a request for changes, by the client user, presenting, by the application program, an interface for the client user to record and/or input a change request for submission to the selected service provider.

11. The method of claim 2, further comprising integrating software and hardware of at least one camera at a site of the project with the application program and streaming a video feed to the client user, on the application program of real time images of the site.

12. A non-transitory computer readable medium having application program instructions stored thereon that upon execution by computer systems of a client user and one or more service provider users, cause the computer systems to:
enable recording or uploading, via the application program, a video describing a project and showing a site of the project, from a client user;
send, via the application program, the video describing the project and showing the site of the project to one or more service provider users who can carry out the project;
enable, via the application program, each of the one or more service provider users to record or upload a video bid for completion of the project;
enable acceptance, via the application program, by the client user of one video bid for completion of the project by a selected one of the one or more service provider users;
create a contract between the client user and the selected service provider user, the contract comprising the video describing the project and showing the site of a project, the video bid for completion of the project from the selected service provider user and a set of terms of service of the application program;
establish, as a part of creating the contract between the client user and the selected service provider user, a set of milestones for completion by the selected service provider to complete the project;
prompt the client user, via the application program and/or via an email, to deposit funds, in the amount of the accepted bid, into an escrow account;
inform, via the application program and/or an email, in response to deposit of the funds in the escrow account, the selected service provider of deposit of the funds in the escrow account and authorization to proceed with the project;
enable an indication, via the application program, by the selected service provider completion of a milestone by the selected service provider;
enable acceptance, via the application program, by the client user completion of the milestone indicated by the selected service provider;
releasing funds from the escrow account, in an amount indicated by the contract for completion of the indicated milestone, in response to acceptance of the completion of the indicated milestone by the client user; and
enable acceptance, via the application program and/or an email, by the selected service provider, the funds from the escrow account.

13. The non-transitory computer readable medium of claim 12, wherein the project is a construction project.

14. The non-transitory computer readable medium of claim 12, wherein, upon execution by the computer systems of the one or more service provider users, the application program instructions cause the computer systems of the one or more service provider users to enable, via the application program, each of the one or more service provider users to request more information, via the application program and/or email, from the client user about the project prior to recording or uploading the video bid for completion of the project.

15. The non-transitory computer readable medium of claim 12, wherein, upon execution by the computer systems of computer systems of a client user and the selected service provider user, cause the computer systems to present, via the application program a timeline of stages of the project.

16. The non-transitory computer readable medium of claim 12, wherein the stages of the project comprise bidding, funding, in-progress, reviewing, and completed.

17. The non-transitory computer readable medium of claim 12, wherein, upon execution by the computer system of the selected service provider user, the application program instructions cause the computer system of the selected service provider user to inform, via the application program and/or an email, in response to the client user accepting the bid for completion of the project from the selected service provider user, the selected service provider user of the acceptance of the bid, that the project is pending funding, the time the client user has to fund the project, and that the selected service provider user will be informed of deposit of the funds in the escrow account and authorization to proceed with the project.

18. The non-transitory computer readable medium of claim 12, wherein, upon execution by the computer system of the client user, the application program instructions cause the computer system of the client user to enable acceptance by the client user of completion of the milestone indicated by the selected service provider further by:
presenting, via the application program, the indication by the selected service provider of completion of the milestone to the client user; and
enabling a selection, via the application program, by the client user between the acceptance of the milestone and a request for changes.

19. The non-transitory computer readable medium of claim 18, wherein, upon execution by the computer system of the client user, the application program instructions cause the computer system of the client user to, in response to selection of a request for changes, by the client user, present, via the application program, an interface for the client user to record and/or input a change request for submission to the selected service provider.

20. The non-transitory computer readable medium of claim 12, wherein, upon execution by the computer systems of computer systems of a client user and the selected service provider user, cause the computer systems to integrate with software and hardware of at least one camera at a site of the project and stream a video feed to the client user and/or the selected service provider, on the application program, of real time images of the site.
